(19) United States
(12) Patent Application Publication
(10) Pub. No.: US 2017/0083911 A1
(43) Pub. Date: Mar. 23, 2017

(54) Information processing device and program

(71) Applicant: Primo Co., Ltd., Tokyo (JP)

(72) Inventor: Abasa PHILLIPS, Tokyo (JP)

(73) Assignee: Primo Co., Ltd., Tokyo (JP)

(21) Appl. No.: 15/250,969

(22) Filed: Aug. 30, 2016

Related U.S. Application Data
(60) Provisional application No. 62/214,995, filed on Sep. 6, 2015.

(30) Foreign Application Priority Data
Nov. 17, 2015 (JP) 2015-224801

(51) Int. Cl. G06Q 20/40; G06Q 20/06

(52) U.S. Cl. CPC G06Q 20/401; G06Q 20/065

(57) ABSTRACT

An information processing device includes a storage in which customer identification information identifying a customer and information about at least one of a virtual currency, a bank account, and a credit card of the customer indicated by the customer identification information are stored to be associated with each other, a receiver configured to receive product identification information indicated by an image read by a customer terminal used by the customer, an association information generator configured to generate association information which is information in which the received product identification information and information as to whether a product corresponding to the product identification information will be delivered to a predetermined place or taken home by the customer are associated with each other, and a purchase processor configured to process purchase of the product by the customer on the basis of the generated association information and the information stored in the storage.

### TECHNICAL FIELD

The present invention relates to an information processing device and program that allow the customer to complete the purchase of products without having to go to the checkout counter.

### BACKGROUND ART

When purchasing a product at a store, the purchaser typically goes to the checkout counter, picks up the purse, and checks out the product. If a line is formed in front of the checkout counter, the purchaser has to wait for his or her turn to come. Also, it is troublesome to pick up the purse to check out the product.

Japanese Unexamined Patent Application Publication No. 2010-61544 discloses a shopping system and computer program that allow the purchaser to select a product while checking the actual product and to purchase it without having to go to the checkout counter.

### SUMMARY OF INVENTION

The checkout-free shopping system disclosed in Japanese Unexamined Patent Application Publication No. 2010-61544 allows the purchaser to purchase a product without having to go to the checkout counter and delivers the product to a previously registered address. Thus, the purchaser can smoothly complete shopping.

However, for a product such as sliced raw fish or ice cream, the freshness thereof is reduced if the time from when the product is selected at the store to when the product is delivered is long. For a product which needs to be delivered in a special condition such as refrigeration, checkout-free shopping is not available. Also, if a purchaser purchases a product that the purchaser wants to use on the day, for example, if a purchaser purchases soy sauce due to the lack thereof, checkout-free shopping is not available. Accordingly, the purchase of these products requires going to the checkout counter finally.

The present invention has been made in view of the foregoing, and an object thereof is to provide an information processing device and program that allow a purchaser to properly complete shopping even when the purchaser purchases a product that is not suitable for checkout-free shopping.

The present invention provides an information processing device including a storage in which customer identification information identifying a customer and information about at least one of a virtual currency, a bank account, and a credit card of the customer indicated by the customer identification information are stored so as to be associated with each other, a receiver configured to receive product identification information indicated by an image read by a customer terminal used by the customer, an association information generator configured to generate association information which is information in which the received product identification information and information as to whether a product corresponding to the product identification information will be delivered to a predetermined place or taken home by the customer are associated with each other, and a purchase processor configured to process purchase of the product by the customer on the basis of the generated association information and the information stored in the storage.

According to the present invention, it is possible to associate the product identification information indicated by the image read by the customer terminal used by the customer with the information as to whether the product corresponding to the product identification information will be delivered to the predetermined place or taken home by the customer. Thus, a certain product can be delivered to the predetermined place, whereas a product which is not suitable for checkout-free shopping can be taken home by the customer.

Various embodiments of the present invention are described below. The embodiments below can be combined with each other.

Preferably, the customer identification information and information indicating the predetermined place are stored in the storage so as to be associated with each other.

Preferably, the storage stores, for each of the customer identification information, a plurality of the information indicating the predetermined place,

wherein the plurality of information comprises information indicating different places.

Preferably, the information processing device further includes a first identification unit configured to identify products determined to be delivered to the predetermined place, of products purchased by the customer from the association information and a first reporting unit configured to report the identified products and the information indicating the predetermined place to a deliverer of the identified products.

Preferably, the information processing device further includes a calculator configured to calculate a sum of prices of products included in the association information and a delivery fee of the products identified by the first identification unit, of the products, and the purchase processor processes the purchase using a calculation result obtained by the calculator.

Preferably, the information processing device further includes a second identification unit configured to identify products determined to be taken home, of the products purchased by the customer from the association information and a second reporting unit configured to report the identified products to a store at which the products have been purchased.

Preferably, the calculator calculates the delivery fee discounted in accordance with the number of the products identified by the second identification unit.

Preferably, the information processing device further includes an acquisition unit configured to acquire location information, and the predetermined place is identified on the basis of the location information acquired by the acquisition unit.

The present invention also provides an information processing program for causing a computer to function as a generator configured to, when an image indicating product identification information is read, generate a screen for making a determination as to whether a product corresponding to the product identification information will be delivered to a predetermined place or taken home.

Preferably, the information processing program causes the computer to further function as an association information generator configured to generate association information which is information in which the read product identification information and the determination are associated with each other.

Preferably, the generator generates a screen for determining whether shopping will be continued, after the determination is made.

Preferably, if it is determined that the shopping will be continued and if an image indicating new product identification information is read, the association information generator adds the new product identification information to the association information.

Preferably, the information processing program causes the computer to further function as an acquisition unit configured to acquire location information, and the predetermined place is selected on the basis of the location information acquired by the acquisition unit.

Preferably, the information processing program causes the computer to further function as a controller, and when the image indicating the product identification information is read, the controller causes the computer to display predetermined information or connects the computer to a predetermined link destination.

Preferably, when the image indicating the product identification information falls within a reading range of the computer, the controller enlarges an image displayed on a display of the computer.

### BRIEF DESCRIPTION OF DRAWINGS

FIG. 1 is a diagram showing an illustrative overview of a system of one embodiment of the present invention;

FIG. 2 is a diagram showing an example hardware configuration of a user terminal;

FIG. 3 is an illustrative function block diagram of the user terminal and a service server of the one embodiment of the present invention;

FIG. 4 are a diagram showing an example of a display of the user terminal of the one embodiment of the present invention;

FIG. 5 is a diagram showing an example of a flowchart of a system of a first embodiment of the present invention;

FIG. 6 is a diagram showing an example of a flowchart of a system of a second embodiment of the present invention;

FIG. 7 is a diagram showing an example of a flowchart of a system of a third embodiment of the present invention;

FIG. 8 are a diagram showing an example of the re-calculation of a fee when a product is additionally purchased according to a fourth embodiment of the present invention; and

FIG. 9 are a diagram showing a case in which a special two-dimensional code is used according to a fifth embodiment of the present invention.

### DETAILED DESCRIPTION

Now, embodiments of the present invention will be described with reference to the drawings. Various features described in the embodiments below can be combined with each other.

### Overview

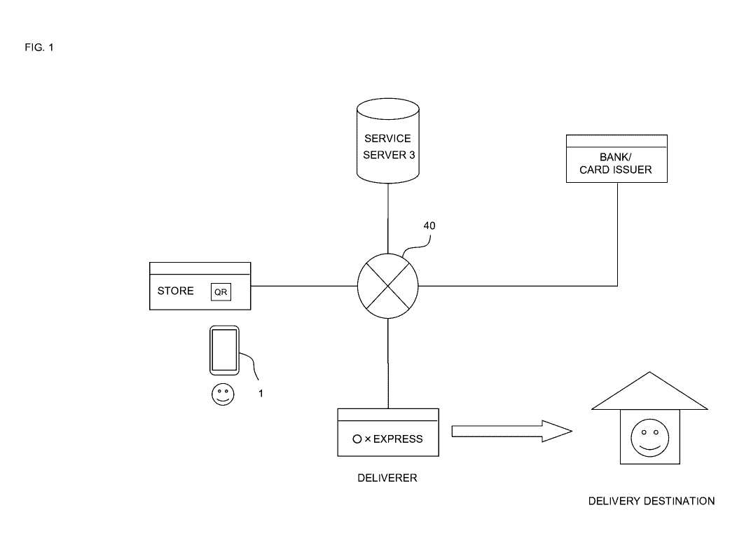

FIG. 1 is a diagram showing an overview of a system of the present invention. A service server 3 that provides a shopping service, a system of a store that sells products, a system of a bank or card issuer, and a system of a product deliverer are connected through a network 40. These parties may be connected by wire or wirelessly.

A user of a shopping service reads an image including product identification information using a user terminal 1 at a store. As used herein, product identification information includes, for example, a product ID identifying a product and the name, price, weight, size, color, and other attributes (the producer, place of production, specialty, etc.) of the product. An image including product identification information is, for example, a QR code® or barcode. In the present embodiment, a QR code is used as an example.

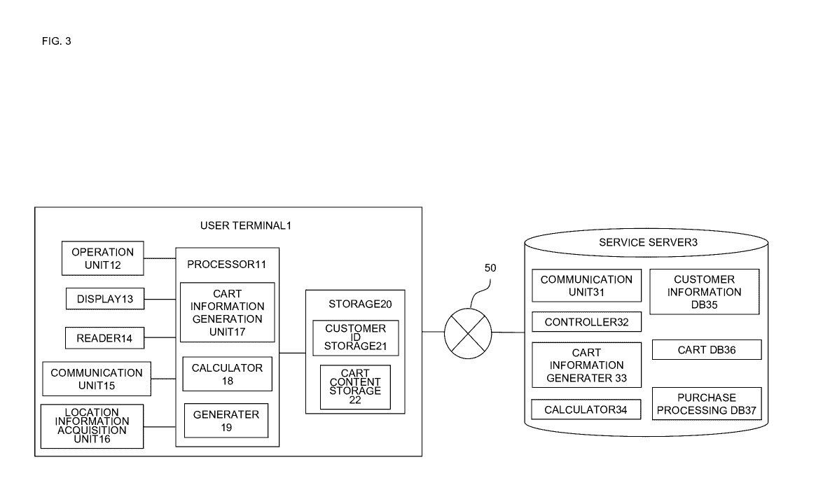

When the user completes shopping, product identification information indicated by QR codes read by the user terminal 1 is transmitted to the service server 3 through the network 50 (see FIG. 3). The service server 3 determines whether the shopping can be paid for, on the basis of information about the money of the user stored therein. As used herein, information about the money is information about at least one of a virtual currency, a bank account, and a credit card and is, for example, the balance of a virtual currency, a bank account number, or a credit card number. In the present embodiment, a virtual currency is used as an example. If the shopping can be paid for (that is, if the balance of the virtual currency is equal to or greater than is more than the total amount of shopping), the service server 3 subtracts the amount required by the shopping from the balance of the virtual currency of the user and sends the amount to the system of the store. When it receives a reply that the money has been sent safely, from the system of the store, the service server 3 completes the purchase processing.

The service server 3 then notifies, to a deliverer, the products purchased by the user and a predetermined place to which the products will be delivered. Optionally, the service server 3 may send the receiver of the products, the delivery date, the delivery time zone, whether wrapping is required, whether each product is fragile, the product loading place, and other information. As used herein, a predetermined place is, for example, a user address previously registered in the service server 3, or a place registered by the user as the delivery destination of a product. Instead of using the user address registered in the service server 3, the user may send an address registered in the user terminal 1 to the service server 3 each time the user uses the shopping service. In the present embodiment, the user address registered in the service server 3 is used as an example. If the store at which the products have been purchased provides delivery services, the deliverer is that store; otherwise, it is, for example, a partner delivery company. The deliverer receives the products purchased by the user and the user address from the service server 3, prepares the products, and delivers the products to the user address.

Hereafter, there will be described a case in which the store at which the user is doing shopping accepts a payment using a virtual currency provided by the provider of the shopping service.

Bitcoin will be described as an example of the virtual currency. Bitcoin is a technology realized using the Peer-to-Peer (P2P) technology and cryptography such as public key cryptography. In Bitcoin, a virtual currency is expressed as a transaction. Each transaction includes a hash of the previous transaction, the public key of the new owner, the cryptographic key of the previous owner, and others. All transactions are shared on a P2P network.

To prevent fraud, such as double-spending, in the virtual currency having such an architecture, the blockchain technology is used. In the blockchain technology, multiple transactions, the previous hash, and other information are defined as a “block.” Only the transactions included in the “block” are recognized as correct transactions. Such blocks are connected in the form of a chain to form one blockchain on the network.

To prove who is the creator of a block, a system called “proof-of-work (POW)” is used. Although anyone can create a block, the creation of a block requires a special calculation using a calculator. For this reason, a predetermined reward is given to one who has created a block using calculation resources. In this way, fraudulent creation of a block is prevented.

If a blockchain is bifurcated, the rule stipulating that a portion having a larger length from the bifurcation point be a correct blockchain may be used.

If the store accepts a payment using Bitcoin, a transaction and block about a payment may be created and the user transfer coins to the store instead of sending money to the system of the store.

### Hardware Configuration

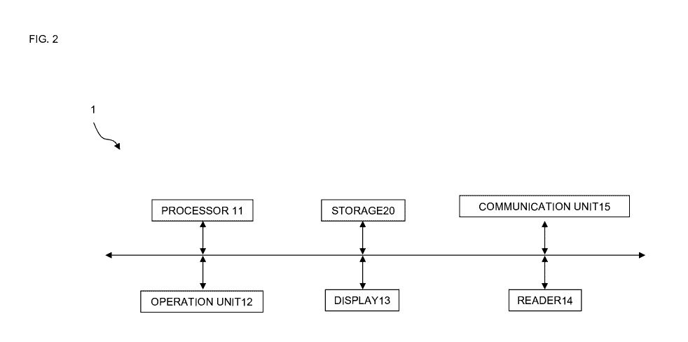

Next, an example hardware configuration of the user terminal 1 will be described with reference to FIG. 2. The user terminal 1 includes a processor 11, a storage 20, a communication unit 15, an operation unit 12, a display 13, and a reader 14. The processor 11 is, for example, a CPU and performs various types of arithmetic processing. The storage 20 is, for example, a memory, HDD, or SSD and stores various types of data or programs. The programs may be preinstalled when shipping the user terminal 1, or may be downloaded from Web sites as applications, or may be wirelessly transferred from other information processing devices. The communication unit 15 is any I/O and transmits and receives various types of data to and from other information processing devices. The operation unit 12 is, for example, a touchscreen, keyboard, and/or voice input unit and is used to operate the user terminal 1. The display 13 is, for example, a touchscreen display or any other type of display and displays various types of images (including still and moving images). The reader 14 is, for example, a camera and reads images or QR codes. The processor 11 controls the user terminal 1 in accordance with the programs stored in the storage 20.

The hardware configuration of the service server 3 is similar to that of the user terminal 1 and therefore will not be described. Note that the reader 14 need not necessarily be provided.

### Function Block Diagram

Next, the functions of the user terminal 1 and service server 3 will be described with reference to a function block diagram in FIG. 3. The user terminal 1 is, for example, a multi-function information terminal, such as a smartphone, tablet terminal, smart watch, or smart glass. The user terminal 1 includes the operation unit 12, the display 13, the reader 14, the communication unit 15, and a location information acquisition unit 16, the processor 11 including a cart information generator 17, a calculator 18, and a generator 19, and the storage 20 including a customer ID storage 21 and a cart content storage 22.

For the functions of the operation unit 12, display 13, reader 14 and communication unit 15, see the description made with reference to FIG. 2.

The location information acquisition unit 16 acquires location information indicating the location of the user terminal 1. For example, it acquires location information using GPS, Wi-Fi®, Bluetooth®, or the like. The cart information generator 17 generates information about products to be purchased by the user. Specifically, it generates cart information indicating a list of the products to be purchased, from product identification information indicated by QR codes read by the reader 14. A QR code may be attached to each product, or may be attached to a shelf on which the same products are displayed. The calculator 18 calculates the total amount of shopping on the basis of the car information generated by the cart information generator 17 [or a cart information generator 33 (to be discussed later)] and information about a delivery fee (not shown). The generator 19 generates a screen for determining whether each product will be delivered or taken home by the user.

The customer ID storage 21 stores an ID which is used to use _the shopping service of the present embodiment and which is a customer ID for uniquely identifying a user. The cart content storage 22 stores the cart information generated by the cart information generator 17 [or the cart information generator 33 (to be discussed later)]. While, in the present embodiment, the customer ID storage 21 and cart content storage 22 are included in the storage 20, these elements may be distributed to multiple storages. The processor 11 controls the other function elements so that those elements cooperate with each other in an organized manner. The user terminal 1 transmits and receives various types of information to and from the service server 3, which is another information processing device, using the communication unit 15 through the network 50.

The service server 3 includes a communication unit 31, a controller 32, the car information generator 33, a calculator 34, a customer information DB 35, a cart DB 36, and a purchase processing DB 37. The communication unit 31 transmits and receives various types of information to and from other information processing devices. In the present embodiment, the communication unit 15 of the user terminal 1 and the communication unit 31 of the service server 3 communicate with each other through the network 50. The controller 32 includes, for example, a processor, a CPU, programs, and the like and controls the other function elements. As with the cart information generator 17 of the user terminal 1, the cart information generator 33 generates information about products to be purchased by the user. As with the calculator 18 of the user terminal 1, the calculator 34 calculates the total amount of shopping on the basis of the car information generated by the cart information generator 33 (or the cart information generator 17) and information about a delivery fee (not shown). While, in the present embodiment, the user terminal 1 includes the cart information generator 17 and calculator 18 and the service server 3 includes the cart information generator 33 and calculator 34, at least one of the user terminal 1 and service server 3 only has to include a cart information generator and a calculator.

For example, if the user terminal 1 alone includes the cart information generator 17, cart information generated by the cart information generator 17 may be transmitted to the service server 3 and stored in the cart DB 36. Conversely, if the service server 3 alone includes the cart information generator 33, cart information generated by the cart information generator 33 may be transmitted to the user terminal 1 and stored in the cart content storage 22. If the user terminal 1 alone includes the calculator 18, a calculation result obtained by the calculator 18 may be transmitted to the service server 3 to update the information in the service server 3. Conversely, if the service server 3 alone includes the calculation unit 34, a calculation result obtained by the calculation unit 34 may be transmitted to the user terminal 1 so that it is displayed on the display 13.

In the customer information DB 35, a customer ID identifying each user, the name of the user, and one or more addresses of the user are stored so as to be associated with each other.

In the cart DB 36, the information about the products to be purchased by the user, that is, the cart information stored in the cart content storage 22 and the customer ID are stored so as to be associated with each other. When the user further reads a QR code and the cart DB 36 receives product identification information indicated by the read QR code, the cart information is updated. While, in the present embodiment, the user terminal 1 includes the cart content storage 22 and the service server 3 includes the cart DB 36, at least one of the user terminal 1 and service server 3 may include the cart content storage 22 or cart DB 36. For example, if the user terminal 1 alone includes the cart content storage 22, the following method may be used: when the reader 14 reads QR codes and the cart information generator 17 generates cart information, the cart information is transmitted to the service server 3 and temporarily stored in a cache or the like (not shown); then, whether the products to be purchased can be paid for is determined on the basis of the balance of the virtual currency of the user stored in the purchase processing DB 37 (to be discussed later); and after the purchase is processed, the products purchased by the user and a predetermined place to which the products will be delivered are transmitted to the deliverer on the basis of the cart information at the time point when the purchase has been processed. Conversely, if the service server 3 alone includes the cart DB 36, the following method may be used: the cart information generator 33 generates cart information; and the cart information is transmitted to the user terminal 1 along with a calculation result obtained by the calculator 34.

In the purchase processing DB 37, the customer ID identifying the user and information about at least one of the virtual currency balance, bank account, and credit card of the user are stored so as to be associated with each other. For example, when the user reads QR codes and thus cart information is generated (updated), the purchase processing DB 37 compares the total amount of the showing with the virtual currency balance to determine whether the shopping can be paid for.

### Display Screen

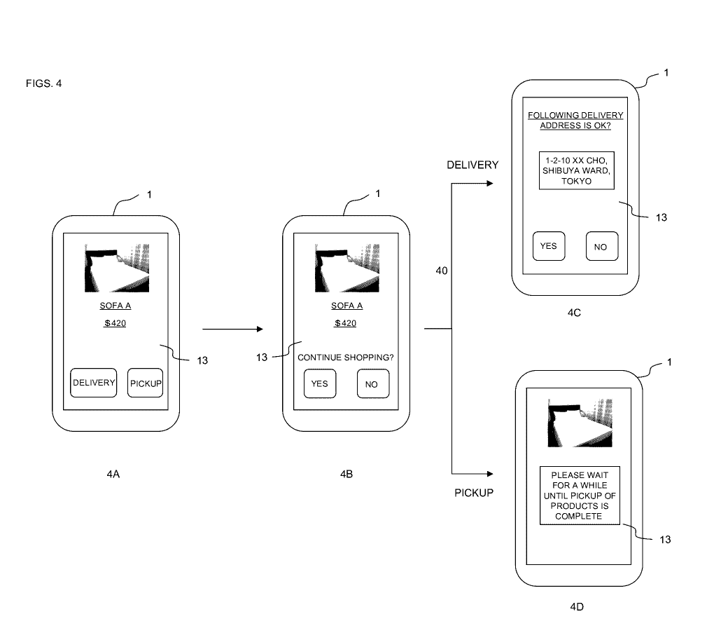

Next, referring to FIG. 4, there will be described an example of the display 13 of the user terminal 1 of one embodiment of the present invention. FIG. 4 are a diagram showing a case

When the QR code of the sofa A is read, the display 13 of the user terminal 1 displays a photograph, the trade name (sofa A), and the price of the sofa A [FIG. 4A]. Note that if a photograph is included in the product identification information, it may or may not be displayed on the display 13. The display 13 also displays a screen for determining whether the sofa A will be delivered to a predetermined place or taken home by the user. If “delivery” is selected, the sofa A will be delivered. At this time, the following procedure may be performed: the user terminal 1 and service server 3 communicate with each other; and if the virtual currency balance of the user stored in the purchase processing DB 37 falls below the sum of $420 and the delivery fee, the display 13 displays a warning screen indicating that the balance is insufficient. The display 13 may also display a screen for charging the virtual currency. On the other hand, if “pickup” is selected, the sofa A will be taken home. At this time, if the virtual currency balance falls below $420, the display 13 may display a warning screen indicating that the balance is insufficient. The display 13 may also display a screen for charging the virtual currency. These screens are generated by the generator 19 and displayed on the display 13.

Note that the above statement that whether the virtual currency balance falls below $420 is determined is intended to simplify the description. Actually, a value obtained by converting the virtual currency balance into $ at the exchange rate at the time point of shopping is used. If the country in which the user does shopping is Japan, the virtual currency balance is converted into yen; if it is China, the virtual currency balance is converted into yuan. If this process is performed by the user terminal 1, it is performed using the latest exchange rate acquired by the communication unit 15 through the Internet; if this process is performed by the service server 3, it is performed using the latest exchange rate acquired by the communication unit 31 through the Internet.

If the store at which the user has done shopping accepts a payment using a foreign currency, the display 13 may display a foreign currency having the most favorable exchange rate with the virtual currency, of foreign currencies which can be used for payments. The exchange fee is also considered.

Subsequently, the generator 19 generates a screen for determining whether the user continues shopping, which is then displayed on the display 13 [FIG. 4B]. If “YES” is selected on the screen shown in FIG. 4B, the user terminal 1 determines that the user has decided the continuation of shopping and is enabled to read QR codes attached other products. If “NO” is selected, the user terminal 1 determines that the user has determined the completion of shopping and displays a confirmation screen before ending shopping [FIG. 4C or 4D].

FIG. 4C is a drawing showing a case in which “delivery” has been selected and shows a previously registered address as a predetermined delivery destination. To use this address as the delivery destination, “YES” is selected; to use another address as the delivery destination, “NO” is selected. If “NO” is selected, a previously registered another address may be displayed, or an address input screen on which the user inputs an address may be displayed. The following procedure may also be performed: if “NO” is selected on the screen shown in FIG. 4B, the previously registered address is determined as the predetermined delivery destination without displaying the selection screen shown in FIG. 4C and thus the shopping is ended.

A function of ending shopping on the basis of location information acquired by the location information acquisition unit 16 of the user terminal 1 may be implemented. For example, this function performs payment processing when the user reads all QR codes attached to desired products, leaves the store, and goes out of a predetermined range from the store. More specifically, this function detects that the user has gone out of a predetermined distance, on the basis of previously registered location information indicating the location of the store and location information acquired by the location information acquisition unit 16 of the user terminal 1 and then performs payment processing.

The following procedure may also be performed: multiple addresses are previously registered in the customer information DB 35 of the service server 3; and the user terminal 1 presents a delivery address to the user on the basis of location information acquired by the location information acquisition unit 16. For example, the address (Tokyo) of the user and the address (Osaka) of the parents of the user are previously registered in the customer information DB 35; if the user reads an QR code using the user terminal 1 at a store in Tokyo, the address of the user is presented as the delivery address; and if the user reads a QR code using the user terminal 1 at a store in Osaka, the address of the parents of the user is presented as the delivery address. In this case, the following procedure may be performed: if the user reads a QR code in a place which is not Tokyo or Osaka using the user terminal 1, the shortest of the distances between the place in which the QR code has been read and the registered addresses is calculated on the basis of the latitude and longitude; and the address having the shortest distance is presented. Also, the following procedure may be performed: instead of the shortest distance, the time required for a delivery vehicle to deliver the purchased product is calculated using map information service or the like on the Internet; and an address taking the shortest delivery time is presented.

FIG. 4D is a drawing showing a case in which “pickup” has been selected. In the present embodiment, if “NO” is selected on the screen shown in FIG. 4B, cart information is transmitted to the server, PC, or the like of the store. Then, the store staff picks up the purchased product and hands it to the user at a product hand-over center or the like. FIG. 4D shows an example of a screen displayed while the store staff has yet to pick up the product. When the store staff has picked up the product and carried it to the product hand-over center or the like, a screen to that effect may be displayed on the display 13 of the user terminal 1. In this case, for example, a map of the inside of the store, the current location of the user acquired by the location information acquisition unit 16 or the like, and the product hand-over center or the like may be displayed on the display 13 in such a manner that the current location and the like are superimposed on the map. Or, a simple message stating that “Please come to the product hand-over center” or the like may be displayed. Or, the following procedure may be performed: a program stored in the storage 20 calls the call function of the user terminal 1; and the store staff places a call to the user and tells the user that the product has been picked up.

### First Embodiment

### Flowchart

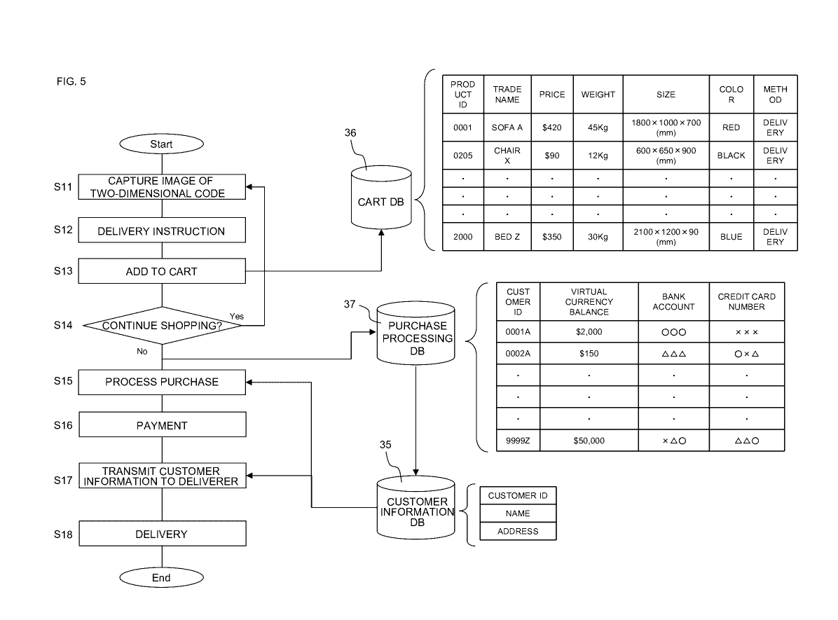

Referring now to a flowchart of FIG. 5, there will be described a process in which the user uses a shopping service provided by an information processing device and information processing program according to a first embodiment of the present invention.

First, in S11, the user finds a desired product at the store and reads a QR code attached to the product using the user terminal 1. In S12, the user selects “delivery” on the screen shown in FIG. 4A to issue an instruction to deliver this product. In S13, the cart information generator 17 generates cart information, which is then stored in the cart DB 36.

In S14, the user terminal 1 displays the screen for determining whether the user will continue shopping shown in FIG. 4B. If the user selects “YES,” the process returns to S11, and the user continues shopping. If the user selects “NO,” the process proceeds to purchase processing in S15. The calculator 18 or calculator 34 calculates the sum of the prices of the products and the delivery fee, and the total amount required by the shopping and the customer ID are reported to the purchase processing DB 37. The purchase processing DB 37 compares the total amount with the virtual currency balance of the user on the basis of the reported customer ID. If the total amount can be paid, the cart information is reported to the customer information DB 35; the amount required by the shopping is subtracted from the virtual currency balance of the user; and that amount is sent to the system of the store. If a reply stating that the amount has been sent safely is received from the system of the store, the payment is completed in S16. In the present embodiment, the customer ID of the user is “0001A,” and the virtual currency balance is $2,000. Accordingly, it is determined that the total amount can be paid.

In S17, the customer information DB 35 transmits the cart information, as well as the customer ID and the name and predetermined address of the user to the deliverer. In S18, the deliverer picks up the products purchased by the user and delivers them to the predetermined address on the basis of these pieces of information. In the present embodiment, a sofa A, a chair X, a bed Z, and the like are purchased, and all these products are determined to be “delivered.” Accordingly, these products are delivered to the predetermined address.

Note that if the scheduled delivery time is more likely to be delayed, information to that effect and the scheduled arrival time may be reported to the user. The reporting method is not limited to a particular method and, for example, those pieces of information may be displayed on the display 13. The following method may also be used: a program stored in the storage 20 calls the call function of the user terminal 1; and the deliverer places a call to the user to notify the user that the scheduled delivery time will be delayed and when the deliverer will arrive.

As seen above, in the present embodiment, the user can make a selection as to whether desired products will be “delivered” or “picked up,” after reading QR codes attached to those products. After paying for the products using the virtual currency without going to the checkout counter, products determined to be “delivered,” of the purchased products are delivered to the predetermined place. If the predetermined address is previously registered, the user need not do anything at this time and thus can seamlessly perform the procedure from the purchase to the delivery of the products.

### Second Embodiment

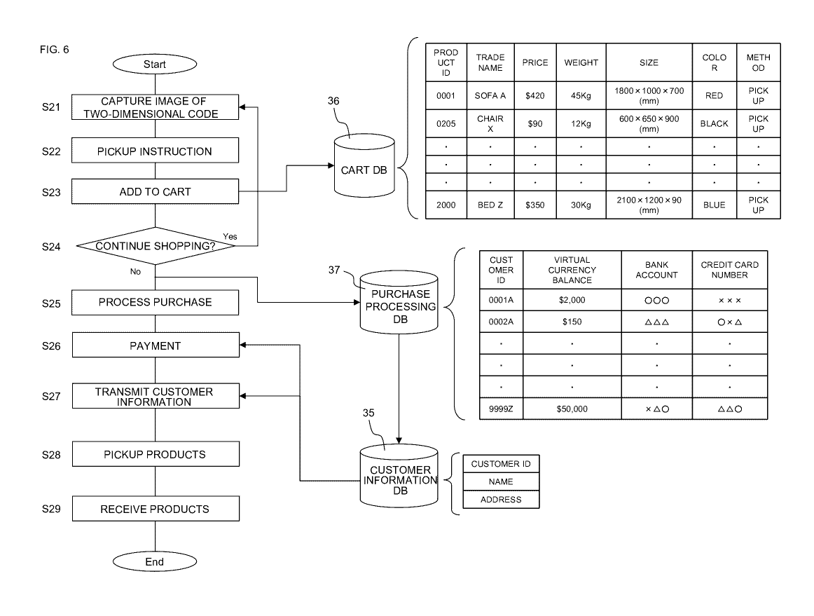

Next, referring to FIG. 6, a second embodiment will be described. In the second embodiment, a case in which “pickup” is selected with respect to all products will be described. S21 to S24 of FIG. 6 are similar to S11 to S14 of FIG. 5 and therefore will not be described.

In S25, the calculator 18 or calculator 34 calculates the sum of the prices of the products, and the total amount required by the shopping and the customer ID are reported to the purchase processing DB 37. The purchase processing DB 37 compares the total amount with the virtual currency balance of the user on the basis of the reported customer ID. If the total amount can be paid, the cart information is reported to the customer information DB 35; the amount required by the shopping is subtracted from the virtual currency balance of the user; and that amount is sent to the system of the store. If a reply stating that the amount has been sent safely is received from the system of the store, the payment is completed in S26. When the payment is completed in S26, the customer information DB 35 transmits the cart information, as well as the customer ID and the name of the user to the system of the store. In S28, the store staff picks up the products purchased by the user and carries them to the product hand-over center on the basis of these pieces of information. When the pickup of the products is completed, the store staff notifies the user that the pickup is complete. The notification method is not limited to a particular method. For example, the following method may be used: the store staff inputs information indicating that “pickup is complete” to the system of the store and transmits the information to the service server 3; and the service server 3 notifies the user terminal 1 that the pickup is complete. Or, the store staff may notify the user using in-store broadcasting or the like. In S29, the user receives the products and goes home.

As seen above, in the present embodiment, the user can make a selection as to whether desired products will be “delivered” or “picked up,” after reading QR codes attached to those products. After paying for the products using the virtual currency without going to the checkout counter, the user can take home the products determined to be “picked up,” of the purchased products.

Further, if the store provides pickup services, the user can take a rest while drinking coffee or the like at a café in the store, until the store staff completes the pickup of the paid products.

If the store does not provide pickup services, the user himself or herself performs S28 and S29.

### Third Embodiment

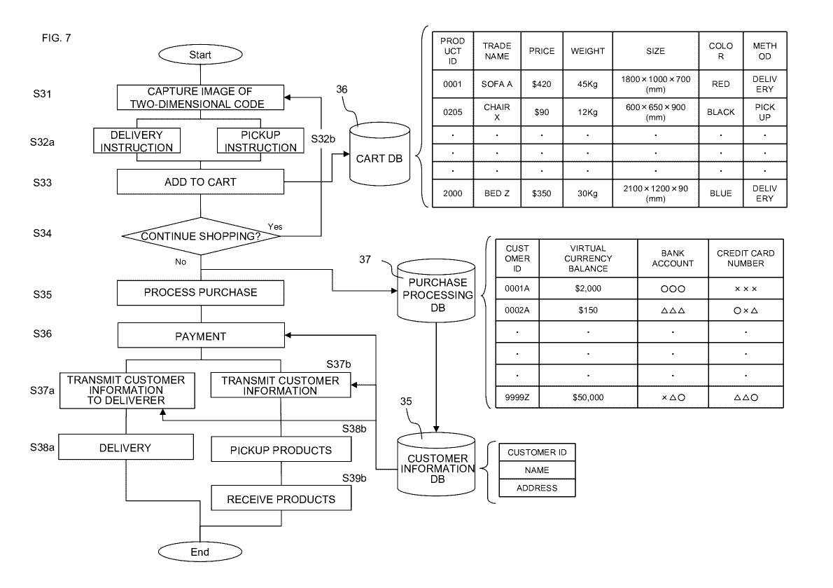

Next, referring to FIG. 7, a third embodiment will be described. In the third embodiment, there will be described a case in which “delivery” is selected with respect to some of purchased products and “pickup” is selected with respect to the other products.

In S31, the user finds a desired product at the store and reads a QR code attached to the product using the user terminal 1. For example, the user reads a QR code attached to a sofa A. In S32a, the user selects “delivery” on the screen shown in FIG. 4A and issues an instruction to deliver the sofa A. In S33, the cart information generator 17 generates cart information, which is then stored in the cart DB 36.

In S34, the user terminal 1 displays the screen for determining whether the user will continue shopping shown in FIG. 4B. If “YES” is selected, the process returns to S31, and the user continues shopping. At this time, the user reads a QR code attached to a chair X. In S32b, the user selects “pickup” on the screen shown in FIG. 4A and issues an instruction to pick up the chair X. In S33, the cart information generator 17 generates cart information, which is then stored in the cart DB 36. These steps are repeated with a bed Z as the last purchased product. In S34, the user completes shopping. In S35, the purchase is processed.

Then, the controller 32 and cart DB 36 collaborate to identify products determined to be delivered to a predetermined place, of the products purchased by the user on the basis of the cart information. Specifically, the controller 32 refers to the cart information stored in the cart DB 36 in FIG. 7 and identifies products having “delivery” in “method” fields thereof. If the products have different delivery destinations, the controller 32 identifies the delivery destination of each product. The controller 32 and cart DB 36 also collaborate to identify products determined to be taken home, of the products purchased by the user on the basis of the cart information. Specifically, the controller 32 refers to the cart information stored in the cart DB 36 in FIG. 7 and identifies products having “pickup” in “method” fields thereof. Then, the calculator 18 or calculator 34 calculates the sum of the prices of the products and the delivery fee required by the products with respect to which “delivery” has been selected. Then, the total amount required by the shopping and the customer ID are reported to the purchase processing DB 37. The “delivery” fee may be discounted in accordance with the number of the “pickup” products. Specifically, the calculator 18 or calculator 34 calculates a discounted delivery fee with reference to data (not shown) in which the number of “pickup” products and the discount rate of the delivery fee are associated with each other. The purchase processing DB 37 compares the total amount with the virtual currency balance of the user on the basis of the reported customer ID. If the total amount can be paid, the purchase processing DB 37 reports the cart information to the customer information DB 35, subtracts the amount required by the shopping from the virtual currency balance of the user, and sends that amount to the system of the store. If it receives a reply stating that the amount has been sent safely, from the system of the store, the purchase processing DB 37 completes the payment in S36.

In S37a, the customer information DB 35 transmits the cart information, as well as the customer ID and the name and predetermined address of the user to the deliverer. In S37b, the customer information DB 35 transmits the cart information, as well as the customer ID and the name of the user to the system of the store.

In S38a, the deliverer picks up the products purchased by the user and delivers them to the predetermined address on the basis of the information transmitted from the customer information DB 35. In the present embodiment, for example, the sofa A, bed Z, and the like are delivered to the predetermined address.

On the other hand, in S38b, the store staff picks up the products purchased by the user and carries them to the product hand-over center on the basis of the information transmitted from the customer information DB 35. In the present embodiment, for example, the chair X and the like are picked up. When the pickup of the products is completes, the store staff notifies the user that the pickup is complete. In S39b, the user receives the products and goes home.

As seen above, in the present embodiment, the user can make a selection as to whether desired products will be “delivered” or “picked up,” after reading QR codes attached to those products. By determining whether the purchased products will be “delivered” or “picked up” after reading the QR codes thereof, the user can properly complete shopping even when products to be delivered and products to be taken home by the user are mixed. In other words, by selecting “pickup” when purchasing a product which is not suitable for checkout-free shopping, the user can consistently complete shopping in a common system or application.

### Fourth Embodiment

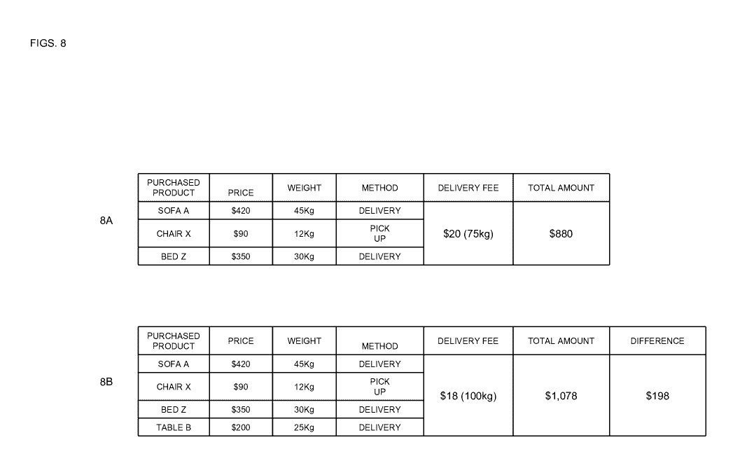

Next, a fourth embodiment will be described. The present embodiment is a case in which after making the payment in S16 of FIG. 5, S26 of FIG. 6, or S36 of FIG. 7, a new product is additionally purchased. As shown in FIG. 8A, the user purchases a sofa A, a chair X, and a bed Z and then attempts to additionally purchase a table B. In this case, after paying for the sofa A, chair X, and bed Z, the user reads a QR code attached to the table B. Thus, the cart information generator 17 generates new cart information as shown in FIG. 8B. At this time, if the user selects, for example, “delivery” with respect to the table B, the calculator 18 or calculator 34 calculates a new delivery fee. In the present embodiment, for example, it is assumed that when the number of purchased products is four or more, the delivery fee is discounted.

By purchasing the table B, the number of purchased products becomes four. Thus, the original delivery fee ($20) is discounted, and a new delivery fee ($18) is calculated. Then, the calculator 18 or calculator 34 sums up the sum of the prices of the products and the delivery fee to calculate the total amount ($1,078) of the shopping. At this time, the user has already paid $880, as shown in FIG. 8A. Accordingly, the difference ($198) between the new total amount ($1,078) and the paid total amount ($880) is calculated. This difference and the virtual currency balance of the user are compared. If the difference can be paid, the payment processing is completed.

### Fifth Embodiment

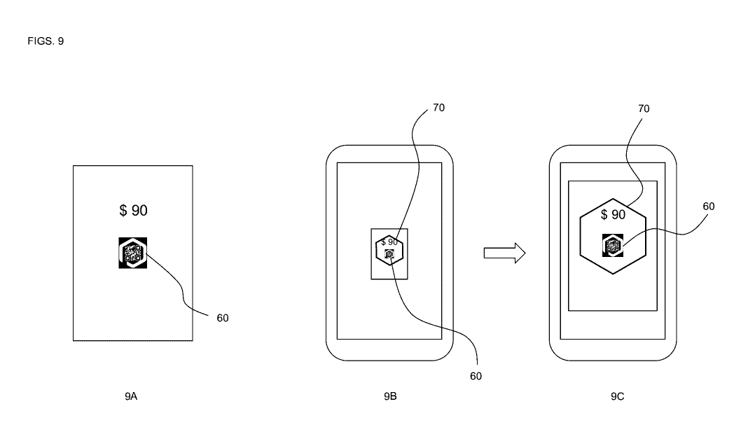

Next, a fifth embodiment will be described. In the present embodiment, there is used a special two-dimensional code attached to a product or a shelf on which products are on show or printed on a price tag. The special two-dimensional code may be any type of two-dimensional code. Hereafter, the special two-dimensional code will be referred to as a two-dimensional code 60. In the present embodiment, a case in which the two-dimensional code 60 is printed on a price tag will be described. FIG. 9A shows a price tag on which the two-dimensional code 60 is printed. It is preferable that there be space between the two-dimensional code 60 and a surrounding pattern, since the presence of space increases the recognition accuracy of the two-dimensional code 60. When the two-dimensional code 60 falls within the reading range of the reader 14 of the user terminal 1, a guide frame 70 is displayed on the display 13, as shown in FIG. 9B. By displaying the guide frame 70, the place of the two-dimensional code 60 can be visibly presented to the user. When the guide frame 70 is displayed, the content displayed on the display 13 is automatically expanded, as shown in FIG. 9(c). By using this function, even the small, printed two-dimensional code 60 is automatically focused and expanded and thus can be recognized. Note that the guide frame 70 may have any shape, size, or color. Subsequently, S11 of FIG. 5, S21 of FIG. 6, or S31 of FIG. 6 is performed.

If an application provided by the provider of the two-dimensional code 60 has yet to be installed in the user terminal 1 when capturing an image of the two-dimensional code 60, a link to a Web site operated by the provider of the two-dimensional code 60 may be displayed on the display 13. Or, a link to a download site for the application provided by the provider of the two-dimensional code 60 may be displayed.

These processes are performed by the processor 11 of the user terminal 1.

### Other Functions

Next, other functions will be described.

When the provider of the present shopping service updates a program used in the service and uploads it to a server on the Internet, the user terminal 1 can install the updated program using a program stored in the storage 20 through the communication unit 15. The installation may be performed manually or automatically. For manual installation, a message indicating that the program has been updated is displayed on the display 13, and the user operates the operation unit 12 to issue an installation instruction. For automatic installation, the user is notified that the program has been updated by push notification, and the updated program is automatically installed. In this case, automatic installation may be permitted only during Wi-Fi connection.

Further, the provider of the present shopping service may cooperate with an SNS used by the user so that the user can upload information about a purchased product to the SNS. In this case, the cooperation may be such that the user can select a product to be uploaded.

While the various embodiments have been described, the present invention is not limited thereto. For example, the following configuration may be used: Instead of providing the cart content storage 22 and a program to the user terminal 1, the service server 3 performs all processing performed by these elements and transmits only the processing results as a so-called Web-base application to the user terminal. While, in FIG. 3, the service server 3 includes the customer information DB 35, cart DB 36, and purchase processing DB 37, these elements may be stored in different information processing devices. While, in the flowcharts in FIGS. 5 to 7, the cart information generator 17 generates cart information, the cart information generator 33 may generate cart information instead. The following configuration may also be used: the user terminal 1 includes a pressure-sensitive sensor; when the pressure-sensitive sensor is weakly touched on the screen shown in FIG. 4, “delivery” or “YES” is selected; and when the pressure-sensitive sensor is strongly touched, “pickup” or “NO” is selected. Note that the degrees of strength of the touch and contents to be selected may be associated with each other in any manner. All or some of the function elements in the function block diagram shown in FIG. 3 and the program may be implemented as hardware components, such as an application specific integrated circuit (ASIC), a field-programmable gate array (FPGA), or a dynamic reconfigurable processor (DRP). The program may be stored in a non-transitory storage medium, such as CD-ROM, and then provided. With regard to the steps described in the embodiments, the change of the order thereof, deletion, addition, or change is possible without departing from the spirit and scope of the present invention.

1. An information processing device comprising:
a storage in which customer identification information identifying a customer and information about at least one of a virtual currency, a bank account, and a credit card of the customer indicated by the customer identification information are stored so as to be associated with each other;
a receiver configured to receive product identification information indicated by an image read by a customer terminal used by the customer;
an association information generator configured to generate association information which is information in which the received product identification information and information as to whether a product corresponding to the product identification information will be delivered to a predetermined place or taken home by the customer are associated with each other; and
a purchase processor configured to process purchase of the product by the customer on the basis of the generated association information and the information stored in the storage.

2. The information processing device of claim 1, wherein the customer identification information and information indicating the predetermined place are stored in the storage to be associated with each other.

3. The information processing device of claim 2, wherein
the storage stores, for each of the customer identification information, a plurality of the information indicating the predetermined place,
wherein the plurality of information comprises information indicating different places.

4. The information processing device of claim 2, further comprising:
a first identification unit configured to identify products determined to be delivered to the predetermined place, of products purchased by the customer from the association information; and
a first reporting unit configured to report the identified products and the information indicating the predetermined place to a deliverer of the identified products.

5. The information processing device of claim 4, further comprising a calculator configured to calculate a sum of prices of products included in the association information and a delivery fee of the products identified by the first identification unit, of the products, and
the purchase processor processes the purchase using a calculation result obtained by the calculator.

6. The information processing device of claim 1, further comprising:
a second identification unit configured to identify products determined to be taken home, of the products purchased by the customer from the association information; and
a second reporting unit configured to report the identified products to a store at which the products have been purchased.

7. The information processing device of claim 6, wherein the calculator calculates the delivery fee discounted in accordance with the number of the products identified by the second identification unit.

8. The information processing device of claim 1, further comprising an acquisition unit configured to acquire location information,
wherein the predetermined place is identified on the basis of the location information acquired by the acquisition unit.

9. An information processing program, comprising:
the information processing program causing a computer to function as a generator configured to, when an image indicating product identification information is read, generate a screen for making a determination as to whether a product corresponding to the product identification information will be delivered to a predetermined place or taken home.

10. The information processing program of claim 9, wherein the information processing program causes the computer to further function as an association information generator configured to generate association information which is information in which the read product identification information and the determination are associated with each other.

11. The information processing program of claim 9, wherein the generator generates a screen for determining whether shopping will be continued, after the determination is made.

12. The information processing program of claim 11, wherein if it is determined that the shopping will be continued and if an image indicating new product identification information is read, the association information generator adds the new product identification information to the association information.

13. The information processing program of claim 9, wherein the information processing program causes the computer to further function as an acquisition unit configured to acquire location information, and
the predetermined place is selected on the basis of the location information acquired by the acquisition unit.

14. The information processing program of claim 9,
wherein the information processing program causes the computer to further function as a controller, and
when the image indicating the product identification information is read, the controller causes the computer to display predetermined information or connects the computer to a predetermined link destination.

15. The information processing program of claim 14, wherein when the image indicating the product identification information falls within a reading range of the computer, the controller enlarges an image displayed on a display of the computer.
